(19) United States
(12) Patent Application Publication
(10) Pub. No.: US 2003/0221797 A1
(43) Pub. Date: Dec. 4, 2003

(54) Medical filing cabinet shelf enclosure system

(76) Inventor: Richard J. Schaller JR., Watchung, NJ (US)

Correspondence Address: Frank M. Linguiti, Esquire, Caesar, Rivise, Bernstein, Cohen & Polotilow, Ltd., 12th Floor, 1635 Market Street, Seven Penn Center, Philadelphia, PA, 19103-2212, US

(21) Appl. No.: 10/455,988

(22) Filed: Jun. 6, 2003

Related U.S. Application Data
(62) Division of application No. 10/314,839, filed on Dec. 9, 2002.
(60) Provisional application No. 60/363,495, filed on May 30, 2002.

(51) Int. Cl. E06B 9/08

(52) U.S. Cl. 160/133

(57) ABSTRACT

A kit for converting an open cabinet to an enclosed cabinet has a top surface, side and bottom panels with cabinet front faces wherein a cabinet front plane is defined by a cabinet front face, including a rolling gate barrel assembly with a rolling gate curtain, side rails and a bottom rail adapted to be secured to the cabinet front faces. The side rails are adapted for attachment to the barrel assembly and to the bottom rail to dispose the barrel assembly above the cabinet top surface when the rails are attached to the cabinet front. Tracks extend along the side rails for permitting the rolling gate curtain to travel within the side rails for enclosing the cabinet enclosure system and maintaining the rolling gate curtain in a spaced apart relationship with the cabinet front plane for the purpose of minimizing damage to cabinet contents.

### RELATED APPLICATIONS

This is a utility application based upon provisional application serial No. 60/363,495, filed on Mar. 13, 2002, entitled “Medical Filing Cabinet Shelf Enclosure System.” Applicant hereby claims for this utility application the benefit of the filing date of the 60/363,495 provisional application whose entire disclosure is incorporated by reference herein.

### BACKGROUND OF THE INVENTION

1. Field of Invention

2. Description of Related Art

It is known to provide rolling gates to cover and protect windows and doors from the elements or for security purposes. For example, see U.S. Pat. No. 4,345,635 entitled “Rolling Protective Gate for Store Fronts or the Like,” issued on Aug. 24, 1982 to Solomon. Solomon teaches a rolling protective gate for store fronts that is formed of a series of horizontally extending transparent slats. The horizontal slats are interconnected and articulated by a series of horizontally extending metal rods. Both the horizontal slats and the metal rods are elongated. Each rod and slat of the rolling protective gate extends the full width of the opening upon which the rolling protective gate is mounted. The protective gate is rolled up and down between a lower, security position and an elevated open position.

U.S. Pat. No. 4,347,866, issued to Von Knorring entitled “Roller Blinds,” issued Sep. 7, 1982 teaches a roller blind suitable for attachment to a supporting structure such as a window frame. The roller blind taught by Knorring is mounted to the window frame by brackets, and is wound and unwound by means of an electric motor.

A rolling shutter device taught in U.S. Pat. No. 5,365,990 issued to Ueda, entitled “Heat Insulating Shutter Device,” issued on Nov. 22, 1994 is adapted to provide heat insulation for a building. The shutter taught by Ueda is formed of a conventional heat insulating material and is disposed over an opening in a wall of a building, such as a door or window. A roller drive is used to wind and unwind the insulating material in order to prevent ingress of outside cold or hot air when the shutter is mounted on the building.

U.S. Pat. No. 5,492,163, entitled “Mounting for a Slider Shuttle,” issued to Allendorfer on Feb. 20, 1996 teaches a system for on-site assembly and attachment of a sliding shutter system for windows or other openings in a building. In the system taught by Allendorfer a sliding shutter box system is premanufactured, assembled at the site of use, and installed in an operational state on a window or comparable opening of a building.

Other prior art directed to rolling gates for windows, doors and the like include U.S. Pat. Nos. 5,575,322, 6,021,837 and 6,302,179 which are issued to James V. Miller on Nov. 19, 1996, Feb. 8, 2000 and Oct. 16, 2001, respectively. The devices taught by Miller in these references include various applications of rolling protective shutters that are formed of a plurality of individual slats and a plurality of hinges interconnecting the individual slats. One of the slats can have an engagement member extending outwardly from one end of the slat. The rolling shutter assemblies bearing the shutter can include features such as a shutter support member, a shutter track, and a stop member disposed within the shutter track.

The shutter and the shutter support member taught by Miller are adapted to permit the shutter to roll from an unrolled position in which the slats are disposed within the shutter tracks, to a rolled position in which the shutter slats are rolled up on the shutter support member. A tension adjust mechanism is provided in at least one embodiment in order to permit adjustment of the tension of a torsion spring. The torsion spring is provided in order to optimize the tension of the shutter. Miller teaches mounting the shutter systems by locating the shutter tracks on either the inside or the outside of the opening being covered.

Recent regulations designed to safeguard the privacy of individuals require that medical records be locked up when not in use. In order to meet these requirements, security devices capable of securely enclosing the records when they are not in use, and conveniently making the records available when they are in use, must be developed. Furthermore, changing over to security devices that meet the regulations must be economical.

While the foregoing prior art rolling gate systems are suitable for use in covering openings such as the openings in the walls of buildings, they are not readily adapted for use on security devices disposed within buildings suitable for meeting the medical record privacy requirements. Furthermore, such indoor security devices must be available in many different shapes and sizes. This makes it even more difficult to directly apply the technology used for mounting rolling gates and shutters to the walls of buildings to the problem of securely storing medical records.

A rectangular shaped security cabinet having a housing with an opening that is closed by a tampour door is taught in “Secure Cabinets,” issued to Moulton on Mar. 22, 1994 as U.S. Pat. No. 5,295,743. The tampour door mounted on the housing is movable along tracks between a first position wherein the housing opening is uncovered and a second position wherein the housing opening is covered by the tampour door. The security cabinet includes two side panels extending from the front of the cabinet housing to the rear. Each side panel of the security cabinet includes a built in track along its front edge for permitting the upward and downward movement of the tampour door.

However, using a security cabinet of the type taught by Moultin to solve the medical records privacy requirements would require purchasing all new cabinets and moving them to the locations where they are needed, transferring all of the medical records from one cabinet to another, and removing all of the old cabinets. This would be a very wasteful solution.

U.S. Pat. No. 4,921,033, entitled “Security Door System,” issued to Finch on May 1, 1990 teaches a security door system having a roll up door for installation in a closet doorway or the like. The security door system of Finch provides secure storage for valuable objects stored within the closet. In order to permit the door of the closet to be closed in a normal fashion when the security door system taught by Finch in the '033 patent is installed, a kit is provided for mounting the security door inside the closet in a parallel spaced-apart relationship with respect to the closet door. In addition to springs, an axle, a barrel assembly, and the security door itself, the mounting kit includes guide tracks and brackets.

The brackets included in the mounting kit of the Finch '033 patent are bolted to the frame of the closet door at the upper corners of the opening of the closet, in order to support the entire security assembly. The guide tracks are fastened to the closet door frame along the sides of the opening in order to guide the wheels of the door during its upward and downward movements. Flexible spacers/runners attached to the security door in line with the wheels riding on the tracks absorb shock during movement of the security door, and thereby help prevent abrasion. Since Finch '033 teaches converting closets to secure storage space having a rolling gate closure, it is not suitable for solving the problem of storing medical records which are currently located in filing cabinets.

U.S. Pat. No. 4,930,563, entitled “Modular Security Door System,” issued to Finch on Jun. 5, 1990 teaches installing a roll up or curtain type closure that can be mounted on a metal shelf storage unit to provide a secure storage assembly. The roll up door is rolled up and down by means of guide tracks which are mounted onto the front edges of the sides of the storage unit. The barrel assembly of the sliding shutter system taught by Finch is mounted over the top of the storage unit. The Finch '563 system is not suitable for converting large numbers of filing cabinet to enclosed secure filing cabinets because it requires a large number of hardware items, is complicated and heavy. Furthermore, the brackets extend laterally beyond the side surfaces of the cabinets, thereby interfering with the desired goal of disposing a plurality of cabinets close to each other in a side by side relationship.

### BRIEF SUMMARY OF THE INVENTION

A kit for converting an open cabinet to an enclosed cabinet is disclosed, the open cabinet having a cabinet top surface, side and bottom panels with cabinet front faces wherein a cabinet front plane is defined by a cabinet front face, including a rolling gate barrel assembly including a rolling gate curtain, side rails and a bottom rail adapted to be secured to the cabinet front faces. The side rails are adapted for attachment to the barrel assembly at upper ends thereof and to the bottom rail at bottom ends thereof to dispose the barrel assembly above the cabinet top surface when the side rails and the bottom rail are attached to the cabinet front. Tracks extend along the side rails for permitting the rolling gate curtain to travel within the side rails from an upper cabinet open position to lower cabinet closed position for enclosing the open cabinet and maintaining the rolling gate curtain in a spaced apart relationship with the cabinet front plane. Fasteners are attached at the bottom end of the side rails for fastening the side rails to the bottom rail. Fasteners are also attached at the upper end of the side rails for fastening the side rails to the barrel assembly thereby forming a frame. A plurality of fastening points are disposed on the side rails for defining locations along a cabinet front face for fastening the side rails to the cabinet front surface at the defined locations.

A method for retrofitting an open cabinet to an enclosed cabinet, the open cabinet having side and bottom panels with a cabinet top surface and cabinet front faces wherein a cabinet front plane is defined by a cabinet front face cabinet includes providing a rolling gate barrel assembly including a rolling gate curtain and providing side rails having respective tracks for permitting the rolling gate curtain to travel along the tracks between an upper cabinet open position and a lower cabinet enclosed position, the tracks being disposed upon the rails in a spaced apart relationship to a rail edge. A bottom rail is also provided. The side rails are attached to the barrel assembly and to the bottom rail to form a frame. The rail edge is disposed against the front surface of the filing cabinet and the frame is attached to the front surface whereby the tracks are maintained in the spaced apart relationship from the cabinet front surfaces.

### BRIEF DESCRIPTION OF SEVERAL VIEWS OF THE DRAWINGS

FIG. 1 shows a perspective view of the filing cabinet shelf enclosure system of the present invention which includes an existing file cabinet.

FIG. 2 shows a perspective view of a side rail suitable for use in retrofitting a filing cabinet in accordance with the method of the present invention in order to form the filing cabinet shelf enclosure system of FIG. 1.

FIGS. 3A,B show enlarged perspective views of portions of the side rail of FIG. 2 in order to better illustrate the threaded side rail studs attached thereto for assembling the filing cabinet shelf enclosure system of FIG. 1.

FIG. 4 shows a perspective view of a bottom rail suitable for use in retrofitting a filing cabinet in accordance with the method of the present invention in order to form the filing cabinet shelf enclosure system of FIG. 1.

FIG. 5 shows a representation of side rails such as the side rail of FIG. 2 and the bottom rail of FIG. 4 assembled in accordance with the method of the present invention in order to form the filing cabinet shelf enclosure system of FIG. 1.

FIG. 6 is an exploded view of the filing cabinet shelf enclosure system of FIG. 1.

### DETAILED DESCRIPTION OF THE INVENTION

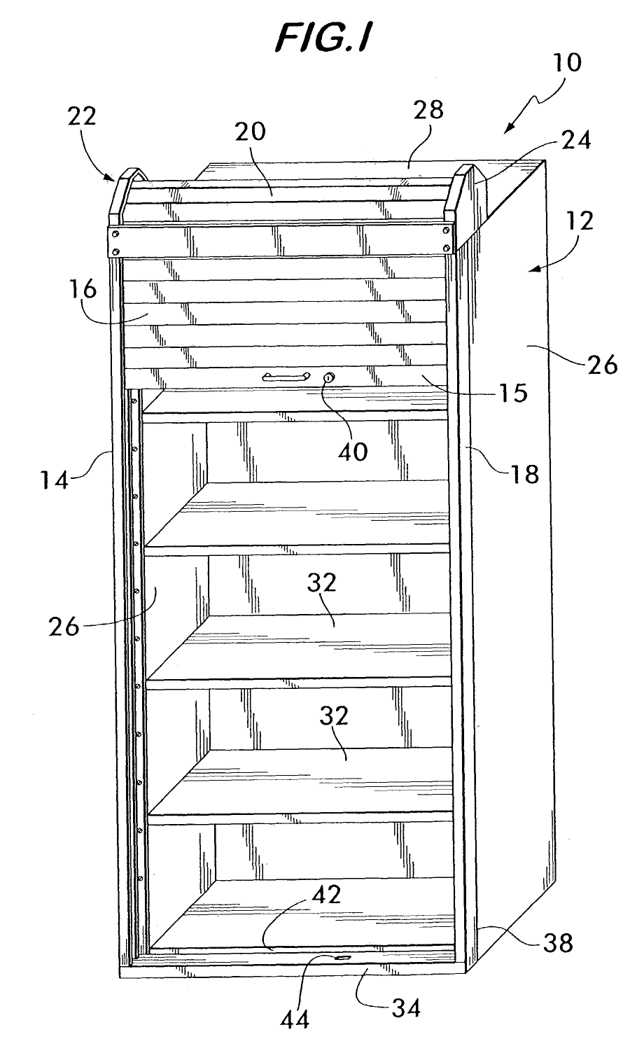

Referring now to FIG. 1, there is shown the cabinet enclosure system 10 of the present invention. The cabinet enclosure system 10 includes a filing cabinet 12 having a plurality of shelves 32, vertical side panels 26, vertical front surfaces 38 on the front of the vertical side panels 26, a horizontal front face 42, and a cabinet top surface 28. The shelves 32 of the cabinet enclosure system 10 can be used to safely store valuable materials thereon. For example, the shelves 32 may contain file records, such as medical records, stored in file folders, such as conventional medical record files.

In order to protect the valuable materials stored on the shelves 32 of the cabinet enclosure system 10, the cabinet enclosure system 10 is provided with a rolling gate system 22 which is attached to the filing cabinet 12. The rolling gate system 22 includes a rolling curtain 16 which is moved from a cabinet closed, down position, for enclosing the cabinet enclosure system 10 and protecting the materials therein, and a cabinet open, up position, for permitting access to the materials stored on the shelves 32.

The rolling gate system 22 also includes a barrel assembly 20 having end caps 24 for containing the rolling curtain 16 when the rolling curtain 16 is rolled up on an axle disposed within the barrel assembly 20. The barrel assembly 20 can be a conventional barrel assembly known to those skilled in the art, wherein a predetermined spring tension is set by the manufacturer. The side rails 14, 18 and the bottom rail 34 are also included in the rolling gate system 22. The barrel assembly 20, the side rails 14, 18, the bottom rail 34, and the fasteners for assembling the all of the foregoing, and attaching them to the filing cabinet 12 are provided as a kit for retrofitting the filing cabinet 12 in order to form the cabinet enclosure system 10. In one preferred embodiment the complete kit required for retrofitting a filing cabinet 12 to form the cabinet enclosure system 10 can weigh less than forty-eight pounds.

The rolling curtain 16 of the rolling gate system 22 is formed of a plurality of hinged or segmented horizontal slats including a base slat 15 the side rails 14, 18 and the bottom rail 34 provide structural integrity to the rolling gate system 22. Additionally, they permit mounting of the rolling gate system 22 onto the filing cabinet 12 to form the cabinet enclosure system 10. When the rolling gate system 22 is mounted on the filing cabinet 12, the barrel assembly 20 of the rolling gate system 22 rests upon the top surface 28 of the filing cabinet 12, the side rails 14, 18 are flush against the front surfaces 38 of the side panels 26, and the bottom rail 34 is flush against the front surface of 42 of the bottom most shelf 32 of the filing cabinet 12.

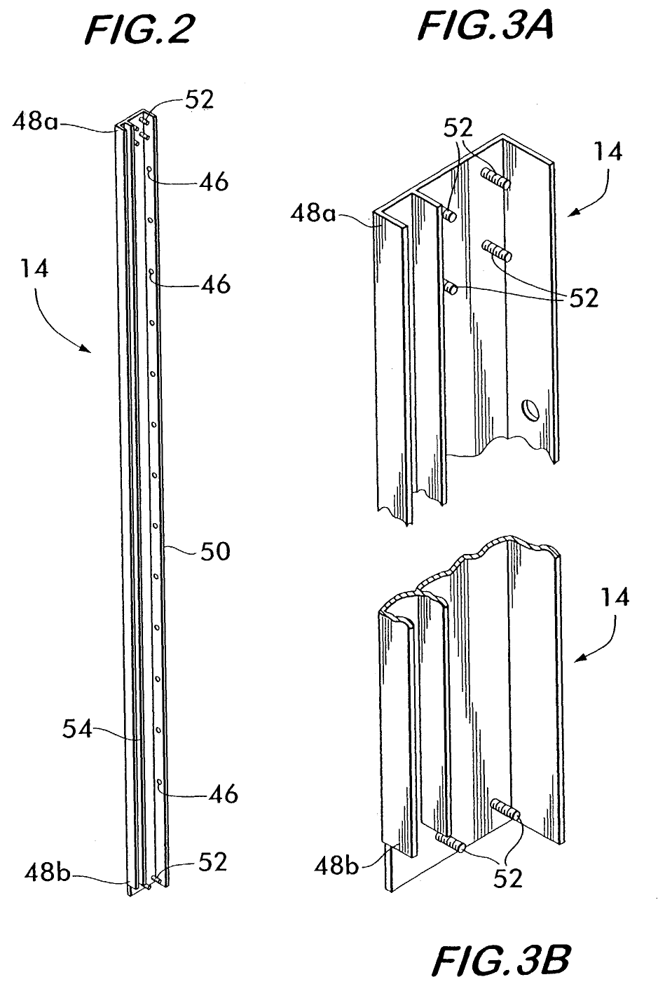

Referring now to FIG. 2, there is shown an enlarged view of the side rail 14 which is attached to the filing cabinet 12 when forming the cabinet enclosure system 10. The side rail 14 has a top end 48a and a bottom end 48b when it is disposed in an assembled position. A vertical curtain track 54 runs along the length of the side rail 14 in order to permit the rolling curtain 16 of the rolling gate system 22 to travel between the top and bottom of the side rail 14. A rear surface 50 of the side rail 14 is adapted to be disposed against the front surface 38 of the side panel 26 of filing cabinet 12 when the rolling gate system 22 is assembled. The side rail 18 is the right hand version of the side rail 14.

Both the vertical curtain track 54 and the base slat 15 of the rolling curtain 16 are formed of metal. Typically, the base slat 15 is formed of aluminum. As the base slat 15 travels up and down within the vertical curtain track 54, metal to metal contact between them must be prevented in order to prevent abrasion. It is known in the art to provide plastic strips along the length of the curtain track 54 to prevent such metal to metal contact. However, in the preferred embodiment of the cabinet enclosure system 10 plastic end caps are applied to the lateral ends of the base slat 15, and inserted into the vertical curtain track 54. Thus, the plastic end caps travel with the base slat 15 along the length of the vertical curtain track 54, preventing contact between the base slat 15 and the vertical curtain track 54. The end caps can be force fitted onto the ends of the base slat 15 or attached in any other manner.

Referring now to FIGS. 3A,B, there are shown further enlarged representations of the top end 48a and the bottom end 48b of the side rail 14 of the rolling gate system 22. The top and bottom ends 48a,b of the side rail 14 are provided with a plurality of attached threaded studs 52 for easy assembly of the rolling gate system 22 to permit easy retrofitting of the filing cabinet 12 with the rolling gate system 22 to create the cabinet enclosure system of the present invention.

In the preferred embodiment of the invention, the threaded studs 52 are welded or otherwise permanently attached onto the side rail 14 at the time of manufacture of the side rail 14. In another preferred embodiment, counter sunk screws can be used to form the threaded studs 52. This method can be used when the side rail 14 is formed of aluminum. The two attached studs 52 at the bottom end 48b of the side rail 14 are received into the bottom rail 34. The four attached studs 52 at the top end 48a of the side rail 14 are received into the barrel assembly 20 at the top of the rolling gate system 22, as described in more detail below.

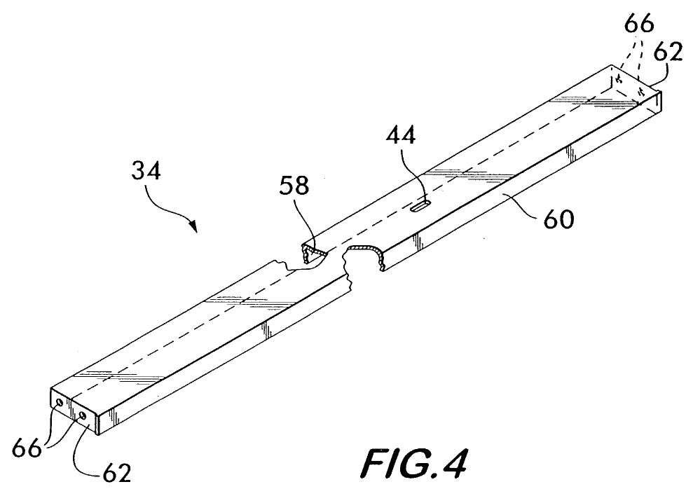

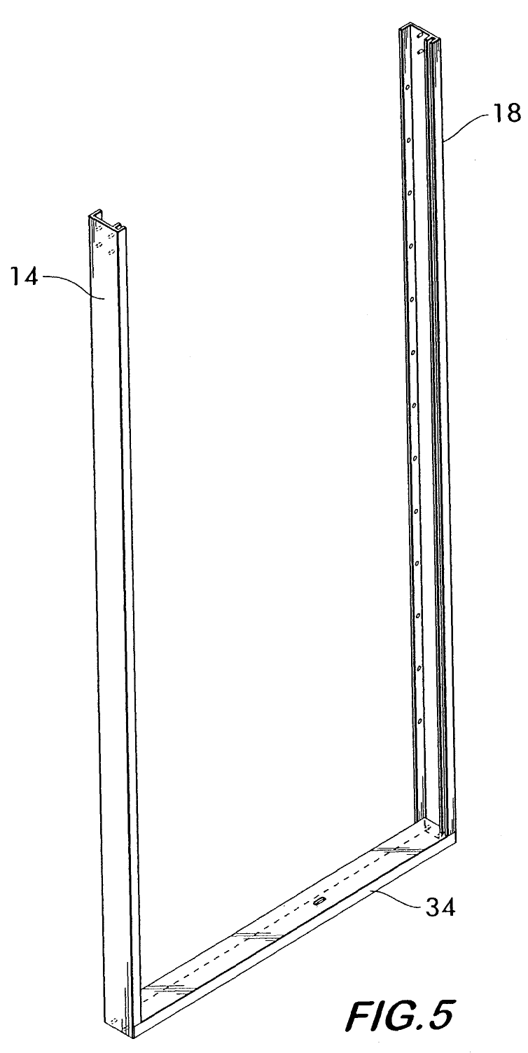

Referring now to FIG. 4, there is shown an enlarged representation of the bottom rail 34 of the rolling gate system 22 according to the present invention. The bottom rail 34 includes a rear surface 60, a front surface 58 and two side surfaces 62. The left side surface 62 is provided with openings 66 for receiving the attached studs 52 of the bottom end 48b of the side rail 14 to permit the side rail 14 and the bottom rail 34 to be threadably joined together during the assembly of the rolling gate system 22, for example using a nut and a washer. In a similar manner, two attached studs 52 at the bottom of the side rail 18 are threadably joined to the right side surface 62 of the bottom rail 34, which is provided with two openings 66 for receiving them. When the side rails 14, 18 are secured to the bottom rail 34 in this manner, three of the four sides of a frame are formed as shown in FIG. 5.

While the side rails 14, 18 and the bottom rail 34 of the rolling gate system 22 can have solid surfaces, as shown in the drawings, in another embodiment they can be formed of a grating material. For example, the side rails 14, 18 and the bottom rail 34 can be a grating material of the type formed by slotting sheets of material and then pulling the edges of the material apart to form a plurality of four sided openings in the material.

Additionally, while the side rails 14, 18 and the bottom rail 34 of the rolling gate system 22 can each be provided as a single integral structure, they can also be provided in a segmented form. When they are provided in such a segmented form, the segments are assembled to form the side rails 14, 18 and bottom rail 34 as part of the process of retrofitting the filing cabinet 12 to form the cabinet enclosure system 10.

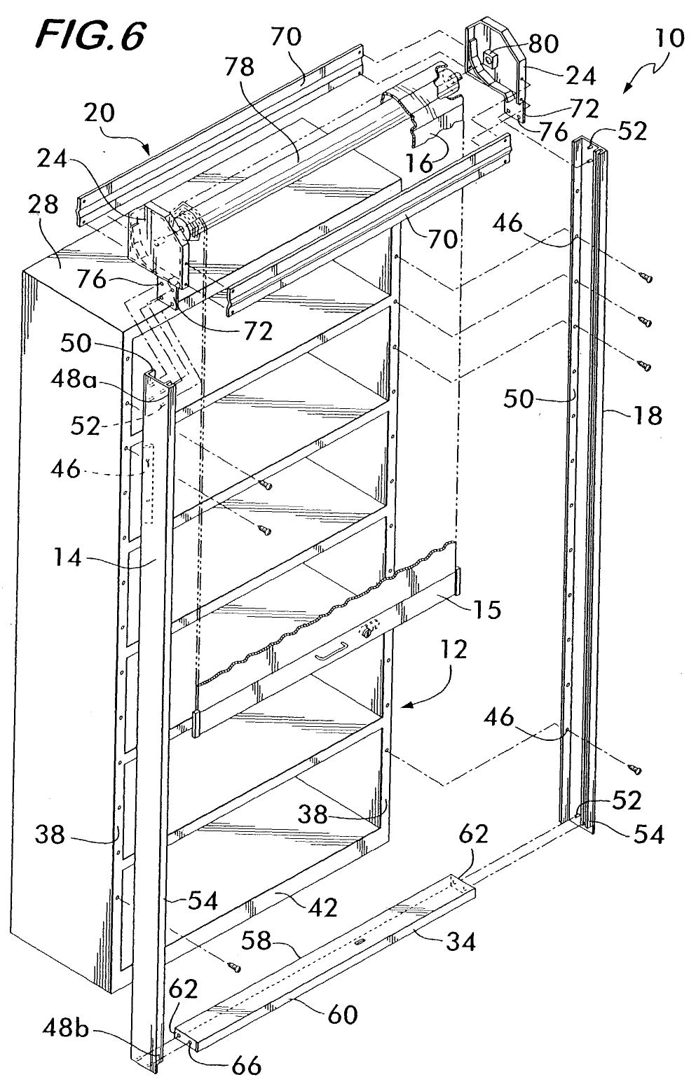

Referring now to FIG. 6, there is shown an exploded view of the cabinet enclosure system 10 of the present invention showing the cover rails 70 and the torsion spring driven axle 78 of the barrel assembly 20, which is disposed upon the top surface 28 of the filing cabinet 12. The torsion spring is loaded as the rolling curtain 16 is pulled down. The loaded torsion spring then assists in pulling the rolling curtain 16 up. In alternate embodiments of the invention, the rolling curtain 16 can be driven by a motor or assisted using counterweights. The end caps 24 of the barrel assembly 20 are provided with axle receiving structures 80 for receiving the ends of the axle 78 and rotatably supporting the axle 78.

In the preferred embodiment the axle receiving structures 80 are attached directly to the inner sides of the end caps 24, for example by welding, rather than being attached by bracket structures in the manner known in the prior art. This permits the ends of the axle 78 to be disposed closer to the end caps 24 and prevents the barrel assembly 20 from extending laterally beyond the sides of the filing cabinet 12. In this manner, the barrel assembly 20 is prevented from interfering with disposing a plurality of cabinet enclosure systems 10 side by side against each other. This feature of the present invention operates cooperatively with the method of attaching the rolling gate system 22 to the filing cabinet 12 without any attachment means extending laterally and interfering with such a side by side positioning.

The exploded view shown in FIG. 6 represents the joining of the side rails 14, 18 to the bottom rail 34 as previously described. Additionally, the connecting side rails 14, 18 to the barrel structure assembly 20 is represented. In order to permit securing the side rails 14, 18 to the barrel assembly 20 each end cap 24 of the barrel structure 20 has a downwardly extending tab 72. Each downwardly extending tab 72 has four tab openings 76. The four tab openings 76 on the downwardly extending tabs 72 receive the four attached studs 52 of the top ends 48a of the side rails 14, 18. When the attached studs 52 at the top and bottom ends 48a,b of the side rails 14, 18 are received and threadably secured in their respective tab openings 76 and bottom rail 34, the rolling gate system 22 is assembled.

When the rolling gate system 22 is assembled, it is disposed against the filing cabinet 12 by resting the barrel assembly 20 upon the top surface 28 of the filing cabinet 12. This disposes the rear surfaces 50 of the side rails 14, 18 against the front surfaces 38 on the side panels 26 of the filing cabinet 12. The rear surface 58 of the bottom rail 34 is disposed against the front surface 42 of the bottom most shelf 32 within the filing cabinet 12. The bottom most shelf 32 thus serves as a bottom panel of the filing cabinet 12.

When the rolling gate system 22 is positioned in this manner, a plurality of fastening points corresponding to the rail openings 46 on the side rails 14, 18 are selected and transferred from the side rails 14, 18 to the front surfaces 38 of the side panels 26 of the filing cabinet 12. The transferred rail openings 46 can be indicated on the front surfaces 38 using any kind of marker, for example, by means of a pencil. Although a larger number of rail openings 46 are provided along the length of the side rails 14, 18, in the preferred embodiment of the invention it is believed that transfer of only four such openings on each side of the filing cabinet 12 is necessary.

When the selected rail openings 46 are transferred to the front surfaces 38 of the filing cabinet 12, the rolling gate system 22 is removed from its position against the filing cabinet 12 and placed in a safe location out of the way. Holes are then drilled through the front surfaces 38 at each of the locations determined by transferring the rail openings 46. For example, a conventional drill can be used to drill eight holes in the front surfaces 38 for each transferred rail opening 46. The drilled holes can be any size suitable for performing the attachment function, for example, the drilled holes can be three-eighth inch.

When the holes are drilled in the front surfaces 38, the rolling gate system 22 is again disposed against the filing cabinet 12 with the barrel assembly 20 resting on the top surface 28 and the side rails 14, 18 and bottom rail 34 disposed against the front surfaces 38, 42. The holes drilled in the front surfaces 38 of the filing cabinet 12 should align with the selected rail openings 46 of the side rails 14, 18. The rolling gate system 22 is then secured to the filing cabinet 12 in a conventional manner using the drilled holes.

For example, push-in rivet fasteners of the type which expand in the space beyond the drilled holes when they are forcibly inserted into the holes can be used to prevent withdrawal of the fastener from the hole and, thereby, to prevent separation of the surfaces being joined. Very significantly, securing the rolling gate system 22 to the front surfaces 38 of the filing cabinet 12 in this manner prevents any materials from extending to the left or to the right of the cabinet enclosure system 10, thereby permitting a plurality of the cabinet enclosure systems 10 to be placed side by side without interfering with each other. Additionally, the method of the present invention permits retrofitting the filing cabinet 12 without moving or emptying the filing cabinet 12.

Push-in fasteners of the type preferred for assembling the cabinet enclosure system 10 are provided by ITW Fastex under the name of Tuflock. This type of fastener is preferred because it is often difficult to obtain access to the space beyond the front surface 38 of some filing cabinets 12 to attach other types of fasteners. However, the rolling gate system 22 can be attached to the filing cabinet 12 in any manner known to those skilled in the art when retrofitting the filing cabinet 12 to form the cabinet enclosure system 10. Where it is possible to use them, screws, nuts and washers, C-chips and V-chips of the type well known to those skilled in the art and other fasteners can be used. Additionally, very strong double sided adhesive tape is available and can be used for the purpose of securing the rolling gate system 22 to the filing cabinet 12.

When the rolling gate system 22 is attached to the filing cabinet 12 in this manner to form the cabinet enclosure system 10, a front surface 38, 42 of the filing cabinet 12 defines a front plane of the filing cabinet 12. The side rails 14, 18 and the curtain tracks 54 are thus maintained in a parallel spaced apart relationship with respect to the front plane thus defined. The distance between the front plane of the filing cabinet 12 and the curtain tracks 54 is selected to prevent the rolling curtain 16 from striking materials disposed on the shelves 32. The distance should be large enough to allow clearance between the rolling curtain 16 and the ends of any files stored on the shelves 32.

For example, when files are disposed upon the shelves 32 and they are not placed all the way against the rear wall of the filing cabinet 12, they may therefore extend forward past the plane of a front surface 38, 42. Enough clearance between the front surface 38, 42 and the rolling curtain 16 must be allowed in order to prevent the rolling curtain 16 from striking such files and thereby damaging them. The amount of clearance required to prevent such damage most of the time is determined by the customary filing habits of the people performing the filing operations.

When sufficient care is exercised, it is expected that that files will be disposed close enough to the rear wall of the filing cabinet 12 that there will be no danger of such damage, and no extra clearance would be required to protect the files. However, in a small percentage of cases, due to a slight lack of care on the part of a person disposing a file on a shelf 32, a file can extend substantially past the front plane of the cabinet enclosure system 10, that is, the file may extend forward far enough that it is in danger of being damaged if the rolling curtain 16 is lowered carelessly. In a very small percentage of cases the file may be disposed upon the shelf 32 so carelessly that the file extends more than a merely substantial distance beyond the front plane of the cabinet enclosure system 10, thereby requiring a very large clearance in order to protect the file.

It is not believed to be prudent to select the clearance in the cabinet enclosure system 10 to be large enough to protect files in the latter cases, since this would waste space and raise costs. However, the horizontal dimensions of the side rails 14, 18 and the bottom rail 34, and therefore the distance between the cabinet front plane and the curtain tracks 54, are selected to provide enough clearance substantial enough to protect a file in cases where at least a reasonable mount of care has been used in placing it upon the shelf 32. A clearance of at least 2.5 inches between the front plane of the filing cabinet 12 and the rolling curtain 16 is believed to be optimum for this purpose in one preferred embodiment of the invention.

The rolling gate system 22 is provided with a slot 44 located on the bottom rail 34. The slot 44 receives a locking tab from a lock 40 located on the base slat 15 for locking the rolling curtain 16 in its completely down position in order to provide security for materials stored within the cabinet enclosure system 10. Thus the lock 40 is disposed close to the ground level when the cabinet enclosure system 10 is locked.

In an alternate embodiment the lock 40 can be disposed substantially above the ground level in order to make it easier to lock and unlock the cabinet enclosure system 10. For example, the lock 40 can be located at least fifteen inches about the ground level. This can be accomplished using a base slat 15 having a greater vertical dimension when the rolling curtain 16 is in its down position that will not interfere with the rolling of the rolling curtain 16 on the axle 78 when the rolling curtain 16 is in its up position. A locking mechanism on such a base slat 15 may act cooperatively with the curtain tracks 54 to lock the cabinet enclosure system 10, for example by means of a friction lock or by insertion through an opening disposed on the side rail 14, 18.

The side rails 14, 18 are provided in a number of different lengths in order to accommodate filing cabinets 12 of different heights. For example, the side rails 14, 18 can be provided in lengths having one foot intervals, such as five feet or six feet, for convenience. In a case where, for example, a filing cabinet 12 has a height slightly less that the height requiring side rails 14, 18 of six feet, then a user of the cabinet enclosure system 10 must obtain a retrofit kit having side rails 14, 18 with a six foot length. This can cause the barrel assembly 20 to be supported a distance above the top surface 28 by the side rails 14, 18. Under these circumstances it is preferred that a barrier plate be disposed behind the barrel assemble 20 extending from the barrel assembly 20 to the top surface 28 of the filing cabinet 12. Such a barrier plate would prevent attempted access to the interior of the cabinet enclosure system 10 by way of the gap between the barrel assembly 20 and the top surface 28.

While the invention has been described in detail and with reference to specific examples thereof, it will be apparent to one skilled in the art that various changes and modifications can be made therein without departing from the spirit and scope thereof.

What is claimed is:

1. A kit for converting an open cabinet to an enclosed cabinet, said open cabinet having shelves for disposing objects thereupon, a cabinet top surface, side and bottom panels with a plurality of cabinet front faces wherein a cabinet front plane is defined by a cabinet front face of said plurality of cabinet front faces, the kit comprising:
(a) a rolling gate barrel assembly including a rolling gate curtain;
(b) a plurality of side rails and a bottom rail adapted to be attached to selected cabinet front faces of said plurality of cabinet front faces;
(c) said plurality of side rails being adapted for attachment to said barrel assembly at upper ends of said side rails and to said bottom rail at bottom ends of said side rails to dispose said barrel assembly above said cabinet top surface when said plurality of said side rails and said bottom rail are attached to said plurality of cabinet front faces; and
(d) tracks extending along said plurality of side rails for permitting said rolling gate curtain to travel within said plurality of side rails from an upper cabinet open position to a lower cabinet closed position for enclosing said open cabinet and maintaining said rolling gate curtain in a spaced apart relationship with said cabinet front plane.

2. The kit for converting an open cabinet of claim 1, further comprising attached fasteners at said bottom end of said side rails for fastening said side rails to said bottom rail.

3. The kit for converting an open cabinet of claim 2, further comprising attached fasteners at said upper ends of said side rails for fastening said side rails to said barrel assembly thereby forming a frame.

4. The kit for converting an open cabinet of claim 3, further comprising a plurality of fastening points disposed on said side rails for defining locations along a cabinet front face of said plurality of cabinet front faces for fastening said plurality of side rails to said cabinet front surface at said defined locations.

5. The kit for converting an open cabinet of claim 1, wherein said spaced apart relationship between said rolling gate curtain and said cabinet front plane comprises a distance between said rolling gate curtain and said cabinet front plane selected to prevent said rolling gate curtain from striking an object disposed upon said shelves in a position extending substantially forward beyond said cabinet front plane.

6. A method for retrofitting an open cabinet to an enclosed cabinet, said open cabinet having side and bottom panels with a cabinet top surface and cabinet front faces wherein a cabinet front plane is defined by a cabinet front face, comprising the steps of:
(a) providing a rolling gate barrel assembly having a rolling gate curtain;
(b) providing side rails having respective tracks for permitting said rolling gate curtain to travel along said tracks between an upper cabinet open position and a lower cabinet enclosed position said tracks being disposed upon said side rails in a spaced apart relationship to a rail edge;
(c) providing a bottom rail;
(d) attaching said side rails to said barrel assembly and to said bottom rail to form a frame;
(e) disposing said rail edge against said front surface of said open cabinet; and
(f) attaching said frame to said front surface whereby said tracks are maintained in said spaced apart relationship from said cabinet front surfaces.

7. The method for retrofitting an open cabinet of claim 6, wherein the step of attaching said frame further comprises the step of applying fasteners to said frame and said open cabinet.

8. The method for retrofitting an open cabinet of claim 7, further comprising the step of providing openings in said front surfaces for receiving said fasteners.

9. The method for retrofitting an open cabinet of claim 8, comprising the further step of providing said openings in said front surfaces of said open cabinet in accordance with fastening points indicated on said front surfaces.

10. An enclosed cabinet enclosure system having a cabinet top surface, side and bottom panels with a plurality of cabinet front faces wherein a cabinet front plane is defined by a cabinet front face of said plurality of cabinet front faces, comprising:
(a) a rolling gate barrel assembly having a rolling gate curtain;
(b) a plurality of side rails and a bottom rail being attached to said cabinet front faces of said plurality of cabinet front faces;
(c) said side rails being attached to said barrel assembly at upper ends of said side rails and to said bottom rail at bottom ends of said side rails to dispose said barrel assembly above said cabinet top surface; and
(d) a plurality of tracks extending along said side rails for permitting said rolling gate curtain to travel within said side rails from an upper cabinet open position to a lower cabinet closed position for enclosing said cabinet enclosure system and maintaining said rolling gate curtain in a spaced apart relationship with said cabinet front plane.

11. The enclosed cabinet of claim 10, further comprising attached fasteners at said bottom ends of said side rails for fastening said side rails to said bottom rail.

12. The enclosed cabinet of claim 11, further comprising attached fasteners at said upper ends of said side rails for fastening said side rails to said barrel assembly thereby forming a frame.

13. The enclosed cabinet of claim 12, further comprising a plurality of fastening points disposed on said side rails for defining locations along a cabinet front face of said plurality of cabinet front faces for fastening said plurality of side rails to said cabinet front surface at said defined locations.

14. The enclosed cabinet of claim 10, wherein said spaced apart relationship between said rolling gate curtain and said cabinet front plane comprises a distance selected to prevent said rolling gate curtain from striking objects disposed upon said shelves in a position extending substantially forward beyond said cabinet front plane.

15. The enclosed cabinet of claim 14, wherein said selected distance between said cabinet front plane and said rolling gate curtain comprises at least 2.5 inches.
